(19) United States
(12) Patent Application Publication
(10) Pub. No.: US 2010/0299694 A1
(43) Pub. Date: Nov. 25, 2010

(54) Receiver And A Processing Method For Data Broadcasting Signal

(76) Inventor: Sung Min Lee, Seoul (KR)

Correspondence Address: MCKENNA LONG & ALDRIDGE LLP, 1900 K STREET, NW, WASHINGTON, DC, 20006, US

(21) Appl. No.: 12/664,247

(22) PCT Filed: Jun. 13, 2008
(86) PCT No.: PCT/KR2008/003343

§ 371 Date: Jul. 12, 2010

(30) Foreign Application Priority Data
Jun. 13, 2007 (KR) 10-2007-0057935

(51) Int. Cl. H04N 7/16; G06F 7/04; H04N 7/173

(52) U.S. Cl. 725/25; 726/4; 713/175

(57) ABSTRACT

A receiver and a method of processing a data broadcasting signal are disclosed. According to the present invention, a storage area is created, with a transfer subject authentication of a permissible application as identification information of a storage area owner. If a received application tries to have access to the storage area, a transfer subject authentication of the application is compared with the identification information of the storage area owner. If they are identical to each other, the received application is permitted to have access to the storage area.

### TECHNICAL FIELD

The present invention relates to a broadcast receiver and a method for processing a data broadcasting signal that includes application.

### BACKGROUND ART

Recently, as rapid development of digital broadcasting, broadcasting stations have transmitted various kinds of data broadcasting signals separately or together with video/audio broadcasting signals.

Data broadcasting platforms may be categorized into OCAP (Open Cable Application Platform), MHP (multimedia Home Platform) and ACAP (Advanced Common Application Platform) data broadcasting.

If a specific application file is created and stored in a storage area of a receiver, it is necessary that other applications should not have access to the storage area. However, a conventional method of preventing the access of the applications to the storage area may not be safe, because the conventional method is in danger of its forgery.

### DISCLOSURE OF INVENTION

### Technical Problem

To solve the problems, an object of the present invention is to provide a method enhancing a security and a broadcasting receiver performing this function by adding permitted condition, when access of a storage area for a received application is permitted.

### Technical Solution

To achieve these objects, a method of processing a data broadcasting signal includes creating storage area, including a transfer subject authentication of an application as an identification of a storage area owner; comparing a transfer subject authentication of a received application with the identification of the storage area owner, if a received application tries to have access to the storage area; and permitting the access of the received application, if the transfer subject authentication is identical to the identification of the storage area owner.

In the creating of the storage area, the storage area further includes an application identification as identification information of the storage area owner.

In the permitting of the access of the received application, the received application may be permitted to have access to the storage area if the application identification and transfer subject authentication of the application trying to have access to the storage area are identical to the application identification and the transfer subject authentication of the storage are owner, respectively.

In another aspect of the present invention, a broadcasting receiver includes a receiving unit, a storage area and an application controller. The receiving unit may receive a data broadcasting signal including an application. The storage area may include a transfer subject authentication of a permissible application as identification information of a storage area owner. The application controller may determine whether a transfer subject authentication of the received application is identical to the identification of the storage area owner, to control the permission of the application.

The application controller may permit the application to have access to the storage area, if a transfer subject authentication of the received application is identical to an identification of the storage area owner.

The application controller may permit the received application to have access to the storage area, if an application identification and a transfer subject authentication of the received application are identical to an application identification and a transfer subject authentication of the storage area owner, respectively.

### ADVANTAGEOUS EFFECTS

The present invention has following advantageous effects.

According to the present invention, whenever an application creates a file, a unique authentication value and an application identification value of a broadcasting station are stored and it may prove that the subject that has created the file is a specific application of a specific broadcasting station. As a result, the other applications of the other broadcasting, except the application of the predetermined broadcasting station that has created its storage area, may not have access to the corresponding file of the storage area. If the certificate information is lost only to permit applications of other broadcasting stations to have access to the storage area, it means that the management of the certificate is not performed well. As a result, it is clear to take responsibility for the lost information.

### BRIEF DESCRIPTION OF THE DRAWINGS

FIG. 1 is a diagram schematically illustrating an overall broadcasting system to which the present invention is applied;

FIG. 2 is a diagram illustrating a concept layer of processing a data broadcasting application and additional information according to the present invention;

FIG. 3 is a flow chart illustrating a method for processing a data broadcasting signal according to an exemplary embodiment;

FIG. 4 is a diagram illustrating an exemplary embodiment to determine whether an application is valid;

FIG. 5 is a diagram illustrating another exemplary embodiment to determine whether an application is valid;

FIG. 6 is a flow chart illustrating a method for processing a data broadcasting signal according to another embodiment; and

FIG. 7 is a block view illustrating an apparatus for receiving a data broadcasting signal according to an exemplary embodiment.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

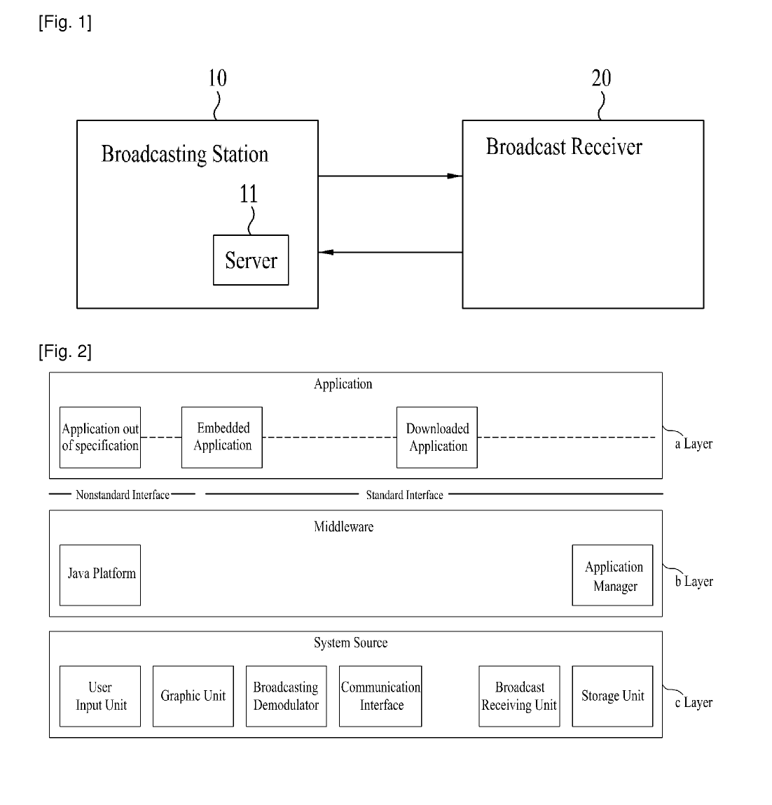

FIG. 1 shows an overall broadcasting system to which the present invention is applied.

The broadcasting system according to the present invention includes a broadcasting station 10 and a broadcasting receiver 20. The broadcasting station includes a server 11.

The broadcasting station 10 transmits a data broadcasting signal including an application to the broadcasting receiver 20. The information of the application is stored in the server 11 of the broadcasting station 10. The information of the application stored in the server 11 may be transmitted via an internet, ran, cable and TCPIP. Also, the broadcasting receiver 20 can communicate with the broadcasting station via a two-way communication line.

At this time, the information of the application stored in the server may be transmitted by using a data transfer method such as Carousel. In Carousel method, data is transmitted repeatedly to use Downlink Channel having a wide bandwidth, compared with Uplink Channel. This Carousel method is embodied as an example and the method for transmitting the information of the application may not be limited to Carousel method and it may be varied.

If a received application tries to have access to a specific storage area, the broadcasting receiver 20 determines whether the application is valid. Hence, the broadcasting receiver 20 permits the application to have an access to the storage area based on the result of the determination.

At this time, as a method for the determination, an organization identification (orgID) and an application identification (appID), that may be included identification information of the application, is compared with identification information that is stored as an owner of the storage area. If the orgID and appID are identical to the identification information of the storage area, it may be determined that the application that has tried to have access is valid.

The specific storage area means a storage area where the file is stored, when the application transmitted by the broadcasting station creates a file. The storage area includes an area that defines identification of a file owner.

To prepare the forgery of orgID and appID, authentication information of a transfer subject that is difficult to forge is compared and it is determined that those argID and appID are valid if the authentication formation is identical to corresponding information of argID and appID.

The authentication information of the transfer subject may be at least one of a digital certificate, a public key, a hash value of a certificate or a hash value of a public key. At this time, the hash value indicates a function value of the certificate or public key, specifically, a value corresponding to a fixed length or a singular value of the certificate or public key. As a result, the hash value of the certificate or the hash value of the public key has a smaller capacity and it is simple to compare those hash values, compared with the certificate or the public key.

FIG. 2 illustrates a layer diagram illustrating a concept of processing the data broadcasting application and additional information according to the present invention. In reference to FIG. 2, an exemplary embodiment of a method for processing a broadcasting signal according to the present invention will be described.

The broadcasting receiver receives broadcasting contents including applications and it processes the received broadcasting contents via functional blocks provided therein. That is, the broadcasting receiver receives broadcasting contents via selected channels and a broadcasting decoder decodes the received broadcasting contents (layer ‘c’).

A user may input a control command for a processing direction of the decoded broadcasting contents via the input unit. Such the control command is transferred to an application platform and the application platform may provide the decoded broadcasting contents to the user.

Here, the application platform including an application manager or a Java platform performs an overall control of the application. Also, the application platform receives a control command from the user and operates a corresponding application via an application interface according to the control command. The application platform receives the application and controls the access of the received application to a specific storage area.

The application platform, which controls the application and monitors a condition of the application, may be referenced to as a middleware.

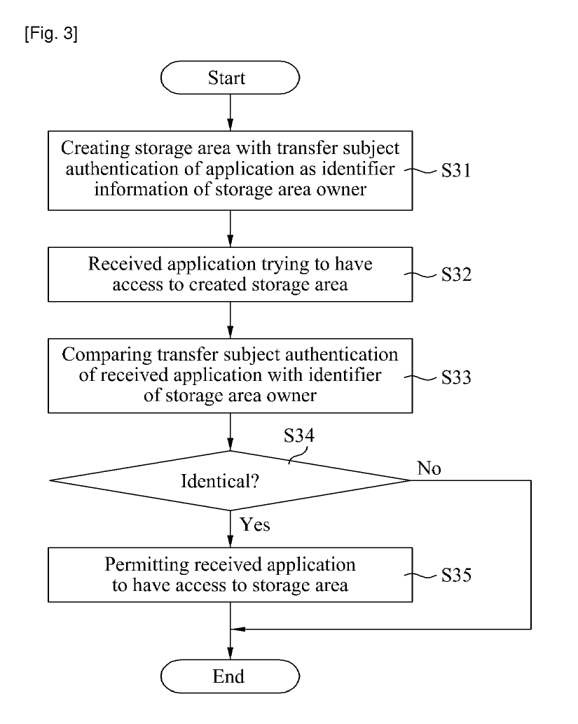

FIG. 3 is a flow chart of a method for processing a data broadcasting signal.

In reference to FIG. 3, the present invention includes steps of creating a storage area with a transfer subject authentication as a storage area owner; comparing a transfer subject authentication of a received application with an identification of the storage area owner, if a received application tries to have access to the storage area; and permitting the received application to have access to the storage area, if the transfer subject authentication of the received application is identical to the identification of the storage area owner based on the result of the comparison.

That is, the creation of the storage area with the transfer subject authentication of the application as identification of the storage area owner (S31) is a step in that qualification of a permissible application is defined when the storage area is created. The storage area may be a physical or logical area. Also, the storage area may be a file. That is, only the transfer subject of the application that creates the storage area may be permitted to have access to the storage area.

In the application's trying to have the access to the storage area (S32), an appID may be included in a permission range of the access to the storage area that is created in S31. Specifically, there is a valid range in the storage area which the application tries to have access to and this means that the received application is included in the valid range. For example, 0x4000-0x7fff, that is an appID, is in the valid range. If the appID of the received application is 0x4000, it is determined that the application is trying to have access.

If the received application tries to have access to the storage area, it is determined whether the access is permissibly valid. If it is determined that the application is valid, the application is permitted to have access to the storage area (S33). That is, if the application that tries to have access to the storage area satisfies a predetermined condition, the application is permitted to have access to the storage area.

Here, it may be determined whether the application is a valid authentication application via a method of determining whether the application has a permission request file to the authentication module storage area. That is, a file element of the application should have a true value.

In addition, according to another method of determining whether the application is a valid authentication application, identifications of applications are defined in a broadcasting receiver in advance. Hence, the identifications are compared with an identification of the application trying to have access to the storage area to determine whether they are identical. If it is authenticated that they are identical, it is determined that the application is a valid authentication application.

The identification information of applications includes an orgID and an appID. The orgID is a piece of information to identify a broadcasting station that transmits applications and the appID is a piece of information to identify a separate application. An orgID and an appID of an application for each broadcasting station are defined in the broadcasting receiver as a permission request. They are compared with the orgID and appID of the application that tries to have access to the storage area to determine whether the application is a valid authentication application.

Furthermore, according to a still further method of determining whether the application trying to have access to the storage area is a valid authentication application, transfer subject authentications of applications are defined in a broadcasting receiver in advance. The transfer subject authentications are compared with a transfer subject authentication of the application trying to have access to the storage area to determine whether they are identical. If the identification is authenticated, it is determined that the application trying to have access to the storage area is a valid authentication application.

The transfer subject authentication of the application includes at least one authentication of a broadcasting station that transmits the application.

The transfer subject authentication of the application may be a certificate or a public key of the broadcasting station that transmits the application. The transfer subject authentication may be a message value of the certificate or public key. Since the transfer subject authentication has substantially little possibility of forgery, applications of other broadcasting stations or applications without authority cannot have access to the storage area.

The public key may be extracted from the certificate.

The message value of the certificate or public key indicates a result value of a message function or algorithm. An example of the message value is a hash value. The hash means that a data block or message with a variable length is corresponding to a fixed length and a singular value that is called ‘a hash code’. An example of the message may be a message digest. An example of the message digest algorithm may be MDS and SHA-1. The message value of the certificate or public key has a smaller capacity than the certificate or public key itself.

At this time, the method of the determination of the validity by the comparison of the identification may be performed independently by using either the message value of the certificate or the message value of the public key. Alternatively, the method may be performed by using the two message values to tighten the security.

If the application is a valid authentication application based on the result of the comparison, that is, an identifier of an owner defined in the storage area is identical to the transfer subject authentication of the received application (S34), the received application is permitted to have access to the storage area (S35).

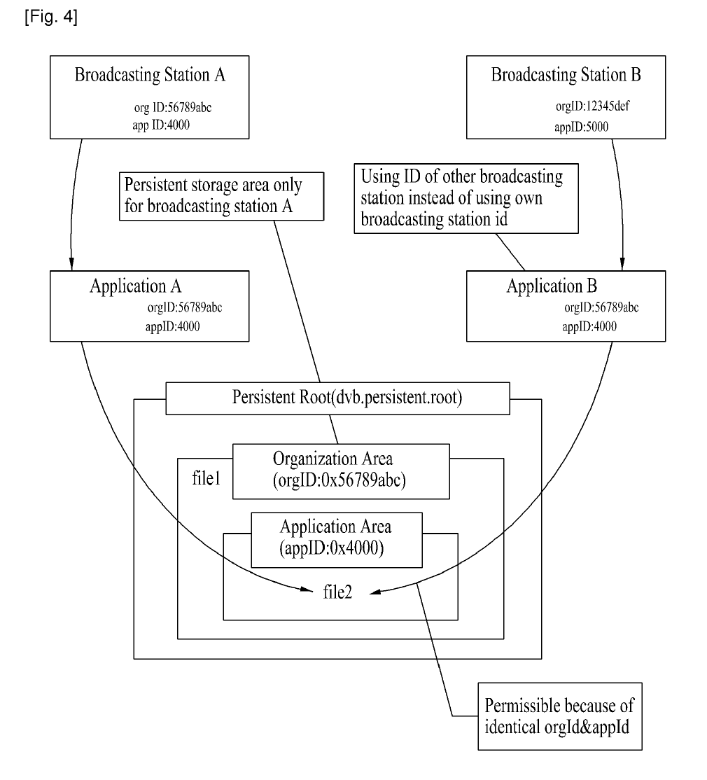

FIG. 4 is an exemplary embodiment of a method for determining whether a received application is a valid application.

In reference to FIG. 4, an application transmitted by different Broadcasting Station B tries to have access to a storage area, rather than Broadcasting Station A that creates the storage area.

When the received application is a valid application that is permitted to have access to the storage area, the identification information of the application, that is, an orgID and an appID of the application may be compared with the identification information of applications defined in advance. Here, if Broadcasting Station B forges the identification of the application defined in advance, it is easy for Broadcasting Station B to have access to the storage area created by Broadcasting Station A.

Accordingly, a case will be described in that Broadcasting Station B tries to have access to a specific storage area that is created by Broadcasting Station A.

Broadcasting Station A may create an organization area in a storage area and an application area in the organization area. That is, the area which the application can have access to is different in the storage area. If an application has an orgID of the organization area, the application may have access to the organization area. If an application has an appID of the application area, the application may have access to the application area.

For example, let us suppose that Application A transmitted by Broadcasting Station B has an orgID of 56789abc value and an appID of 4000 value.

At this time, although Application B transmitted by Broadcasting Station B has an orgID of 12345abc value and an appID of 5000 value, the application identification of Broadcasting Station B may be forged to have the orgID of 56789abc value and the appID of 4000 value.

In this case, Application A transmitted by the Broadcasting Station B is permitted to have access to the storage area of Broadcasting Station A.

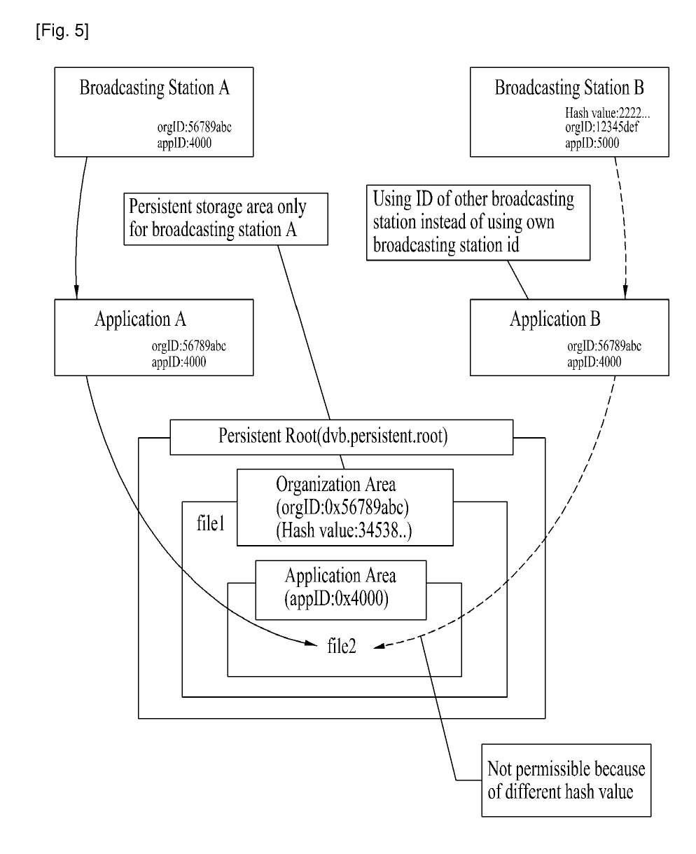

FIG. 5 illustrates another embodiment of a method for determining whether a received application is a valid authentication application.

In reference to FIG. 5, Application A transmitted by different Broadcasting Station B from Broadcasting Station A that creates a storage area may not have access to the storage area.

That is, when determining whether the received application is a valid authentication application having permission of access to the storage area, the authentication of Broadcasting Station A is compared and identified, rather than the comparison of the identification information of the application, that is, an orgID and an appID of the application. Based on the result of the comparison, it is determined whether the application is permitted to have access to the storage area created by Broadcasting Station A.

An example will be described in that access of Application B transmitted by Broadcasting Station B is limited to a specific storage area created by Broadcasting Station A.

Broadcasting Station A may create an organization area in a storage area and an application area in the organization area. That is, the area which the application may have access to is different within the storage area. If an application has an orgID of the corresponding organization area and authentication of the transmitter, the application has access to the organization area. If an application has appID of the corresponding application area, the application has access to the application area.

For example, Application A transmitted by Broadcasting Station A has an orgID of 56789abc value, a hash value of 34538 value as the authentication of Broadcasting Station A, and an appID of 4000 value.

At this time, although an identifier of Application B transmitted by Broadcasting Station B has an orgID of 1234def value and an appID of 5000 value, the application identifier may be forged to have an orgID of 56789abc value and an appID of 4000 value.

In this case, a broadcasting receiver determines whether Application A is permitted to have access to the storage area by using the authentication of the transmitter, together with the orgID and the appID of the application. If then, Application B of Broadcasting Station B may not have access to the storage area created by Broadcasting Station A. that is, it is possible to forge the orgID and the appID of the application and it is difficult to forge the authentication of the broadcasting station. As a result, the security may be tightened and improved.

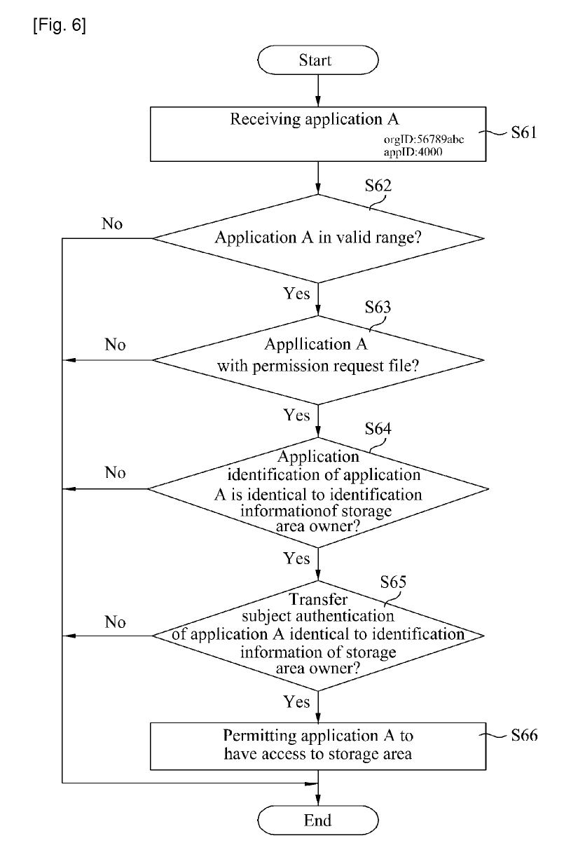

FIG. 6 illustrates a method for processing a broadcasting data according to another embodiment.

In reference to FIG. 6, an overall flow chart for processing a received application will be described.

Application A is received (S61) and information for identifying Application A includes an orgID (for example, a value of 56789abc) and an appID (for example, a value of 4000). In addition, the identification information for identifying Application A may include an authentication of a transmitter of Application A, for example, a hash value.

If a received application tries to have access to a specific storage area, an application platform performs Storage Proxy Manager and Storage Proxy Manager performs functional call of getStorageProxy( ) to search a physical storage area. Specifically, if calling a function of getStorageProxy( ) at least one physical spatial array, that can be storable, is searched. It is determined whether the discovered at least one physical area is a persistent storage area. In other words, it is determined whether there is a storage area called ‘flash’ out of the plurality of the called storage areas and loop until the flash is found.

It is performed next that a logical area having an authentication module stored therein is searched in the flash.

Specifically, a function of getVolumes( ) is called and an array of Logical Storage Volume (hereinafter, LSV) is searched. If LSV that is a predetermined storage area is searched, it is determined whether the received application is correspondingly in the valid range (S62), that is, the received application is included in the valid range to have access to the storage area. The determination may be performed by using the appID. For example, if the valid range of the storage area is from an appID of 0X4000 to an appID of 0x7fff, it is determined whether the appID of the received application is included in the above valid range.

If the received application is included in the valid range, it is determined whether the application trying to have access to the specific storage area has a permission request file (S63). If a value of the permission request file is true based on the result of the determination, a next step will be performed.

The temporal order of S62 and S63 may be changeable.

That is, it is determined whether the identification of the owner of the specific storage area is identical to the identification of the application trying to have access to the specific storage area (S64). If they are identical to each other, it is determined again whether the transfer subject authentication of the application is identical to the authentication of the storage area (S65).

As mentioned above, when determining whether the received application is valid, the transfer subject information of the application, as well as the orgID and the appID that are identification information of the application, is also compared and determined. That is, when the storage file of the storage area is created, the application identification information and the transfer subject authentication information are used as the identification information of the storage area owner. At this time, if the application identifications are identical, it is determined whether the transfer subject authentications are identical. Alternatively, once the orgID and the transfer subject authentication of the application are compared first and then the appID of the application may be compared to determine whether the application has access to the storage area lastly. Alternatively, after the transfer subject authentications are compared first, the application identifications may be compared later. The temporal order is not important and the unique technical feature of the present invention is that the transfer subject authentication information is used when determining whether the received application is permitted to have access to the storage area.

In addition, together with the application identification, the transfer subject authentication may be compared to determine whether the application is permitted to have access to the storage area. Alternatively, only with the comparison of the transfer subject authentication, it may be determined whether the received application has access to the storage area.

If the identifier of the storage area is identical to the identifier of the application based on the result of the determination, the received application is permitted to have access to the storage area (S66).

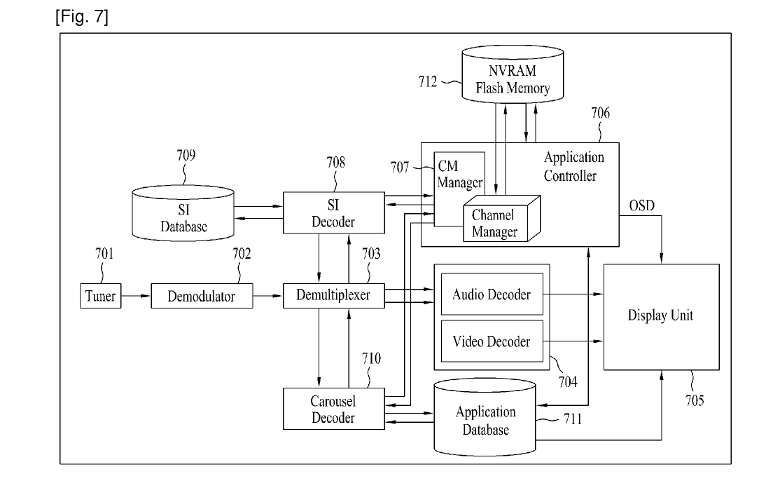

FIG. 7 is a block view illustrating a broadcasting receiver capable of receiving data broadcasting according to an embodiment of the present invention.

In reference to FIG. 7, the broadcasting receiver includes a receiving part, a storage area and a controller. The receiving part receives a data broadcasting signal including an application. Transfer subject authentication information of a permissible application is stored in the storage area as identification information of an owner of the storage area. The controller determines whether a transfer subject authentication of a received application is identical to the identification information of the storage area and controls whether the received application is permitted to have access to the storage area.

More specifically, the data broadcasting receiver includes a receiving unit 701, a demodulator 702, a demultiplexer 703, an audio/video decoder (A/V decoder) 704, a display unit 705, an application controller 706, a channel manager 707, a system information decoder (SI decoder) 708, a system information database (SI database) 711, a carousel decoder 710, an application database 711, a NVRAM or flash memory 712, a controller (not shown). The data broadcasting receiver may be connected with an external cablecard.

The receiving unit 701 may includes a tuner and it may receive a data broadcasting signal including an application. Here, the receiving unit 701 may receive an A/V signal as well as the broadcasting signal. The receiving unit 701 may be controlled by the channel manager 707 and it may report the result and strength of the received signal to the channel manager 707.

The demodulator 702 demodulates the broadcasting signal outputted from the receiving unit 701 and the demodulated signal is transmitted to the demultiplexer 703. At this time, when demodulating the signal, if the broadcasting signal received from the receiving unit 701 is a signal of a terrestrial broadcasting, the demodulator 702 may perform vestigial side band (VSB). If the broadcasting signal is a cable broadcasting signal, the demodulator 702 may perform quadrature amplitude modulation (QAM) or VSB.

The demultiplexer 703 demultiplexes the received broadcasting signal demodulated at the demodulator 702. That is, the demultiplexer 703 may filter data relating to audio, video and data broadcasting, that includes an application, from the input transmission stream packets.

Specifically, the demultiplexer 703 may demultiplex the demodulated broadcasting signal under the control of the SI decoder 708 and/or the carousel decoder 701. For example, the demultiplexer 703 may separate the data, relating to audio, video and data broadcasting, from the transmission stream packets and also it may separate tables that control the demultiplexing and decoding of the audio, video and data. At this time, the demultiplexer 703 checks a header that is common in each table to perform the demultiplexing.

The demultiplexer 703 may create a table section for an A/V broadcasting service and transmit the table section to the SI decoder 708. The demultiplexer 703 may filter the carousel data to create a table section for the data broadcasting service in relation to the present invention and it may transmit the table section to the carousel decoder 710.

In addition, the demultiplexer 703 may demultiplex A/V transmission stream packets under the control of the channel manager 707. As a result, if an A/V packet identifier (A/V PID) of a virtual channel is set, the demultiplexer 703 demultiplexes an elementary stream of the A/V and transmits the demultiplexed streams to the A/V decoder 704, respectively.

The A/V decoder 704 receives the A/V elementary stream packets from the demultiplexer 703 and decodes them via a predetermined method such as MPEG-2, AC3 or the like. The A/V decoder 704 synchronizes the decoded A/V data by using a video display processor (VDP) and it transmits the synchronized data to the display unit 705.

If the decoded A/V data is a video signal, the display unit 705 outputs the video signal via a screen. If the decoded A/V data is an audio data, the display unit 705 outputs the audio signal via a speaker. At this time, if the output data decoded at the A/V decoder 704 is the video signal to be outputted via the screen, the display unit 705 is under control of on-screen-display graphic data (OSD graphic data).

The channel manager 707 manages a channel map and controls the receiving unit 701 and the SI decoder 708, to respond to a channel request of a user. The channel manager 707 receives a request of parsing the channel relating table of a channel that will be tuned to the SI decoder 708 and the result thereof, such that the channel map is updated based on the received result and that the A/V PID is set at the demultiplexer 703 to request the decoding of the A/V PID.

The SI decoder 708 is a SI control module that parses the table section included in the broadcasting signal and it may perform a slave operation under the control of the channel manager 707.

Specifically, the SI decoder 708 may control the demultiplexer 703 to parse the table section included in the broadcasting signal. In other words, the SI decoder 708 sets a PID for a corresponding table in the demultiplexer 703 and it controls the demultiplexer 703 to create its corresponding table section.

In addition, the SI decoder 708 may receive and parse a PSI section or PSIP section separated from the demultiplexer 703. The SI decoder 708 may store the parsed information in the SI database 709.

At this time, the SI decoder 708 parses, in other words, reads all of the other actual section data that is not filtered at the demultiplexer 703 to record the parsed data in the SI database 709.

The carousel decoder 710 may receive and parse data, relating to the data broadcasting, that is transmitted from the demultiplexer 703. The carousel decoder 710 may store the parsed data in the application database 711 or the NVRAM or flash memory 712 and it may check whether it is updated. As a result, if the updating occurs, the carousel decoder 710 may keep the information stored in the application database 711 on updating by reinterpretation of the data.

In addition, the carousel decoder 711 may perform the slave operation under the control of the channel manage 707, like the SI decoder 7008.

The NVRAM or flash memory 712 is divided into predetermined areas and it may control the access of applications. When creating predetermined storage areas, identification information of a corresponding storage area may be defined. The identification information of the storage area may include an orgID and an appID, which are identification information of an application, and transfer subject authentication information.

The application controller 706 determines whether an application trying to have access to the storage area has permitted to have the access. The control of the application mentioned above is performed and the description thereof is applicable.

In addition, the application controller 706 receives a decoding condition from the A/v decoder 704 to control the display unit 705 via the OSD data. At this time, the application controller 706 may manage and control an application status, a database and the OSD relating to the data broadcasting.

The application controller 706 may control the channel manager 707 to perform the channel relating operation, including the channel map management and operation of the SI decoder. Also, the application controller 706 may control a graphic user interface (GUI) of the television. The application controller 706 may store and recover a user request and a television system status in the NVRAM or flash memory 712.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method of processing a data broadcasting signal comprising:
creating storage area, the storage area including a transfer subject authentication of a permissible application as identification information of a storage area owner;
comparing a transfer subject authentication of a received application with the identification information of the storage area owner, if a received application tries to have access to the storage area; and
permitting the received application to have access to the storage area, if the transfer subject authentication of the received application is identical to the identification of the storage area owner.

2. The method as claimed in claim 1, wherein the comparing of the transfer subject authentication of the received application with the identification of the storage area owner comprises:
determining whether there is a permission request file, if the received application tries to have access to the storage area; and
determining whether a file element of the permission request file is true.

3. The method as claimed in claim 1, wherein the storage area further includes an application identification as identification information of the storage area owner.

4. The method as claimed in claim 3, wherein the comparing of the transfer subject authentication of the received application with the identification of the storage area owner further comprises:
comparing an application identification of the application trying to have access to the storage area with an application identification of the storage area owner.

5. The method as claimed in claim 4, wherein in the permitting of the access of the received application, the received application is permitted to have access to the storage area, if an application identification and a transfer subject authentication of the application trying to have access to the storage area are identical to the application identification and the transfer subject authentication of the storage are owner, respectively.

6. The method as claimed in claim 1, wherein the transfer subject authentication of the application comprises at least one of an certificate, a public key, a message value of a certificate and a message value of a public key.

7. The method as claimed in claim 6, wherein the message value of the certificate is a hash value of the certificate.

8. The method as claimed in claim 6, wherein the message value of the public key is a hash value of the public key.

9. A broadcasting receiver comprising:
a receiving unit which receives a data broadcasting signal including an application;
a storage area including a transfer subject authentication of a permissible application as identification information of a storage area owner; and
an application controller which determines whether a transfer subject authentication of the received application is identical to the identification information of the storage area owner, to control the permission of the application to have access to the storage area.

10. The broadcasting receiver as claimed in claim 9, wherein the application controller determines whether the application is permitted to have access to the storage area, if there is a permission request file in the received application and an file element of the permission request file is true.

11. The broadcasting receiver as claimed in claim 9, wherein the application controller permits the application to have access to the storage area, if the transfer subject authentication of the received application is identical to the identification information of the storage area owner.

12. The broadcasting receiver as claimed in claim 9, wherein the storage area further includes an application identification as the identification information of the storage area owner.

13. The broadcasting receiver as claimed in claim 12, wherein the application controller permits the received application to have access to the storage area, if an application identification and a transfer subject authentication of the received application are identical to the application identification and the transfer subject authentication of the storage area owner, respectively.

14. The broadcasting receiver as claimed in claim 9, wherein the transfer subject authentication of the application comprises at least one of a certificate, a public key, a message value of a certificate and a message value of a public key.

15. The broadcasting receiver as claimed in claim 14, wherein the message value of the certificate is a hash value of the certificate.

16. The broadcasting receiver as claimed in claim 14, wherein the message value of the public key is a hash value of the public key.
